(19) United States
(12) Patent Application Publication
(10) Pub. No.: US 2003/0150388 A1
(43) Pub. Date: Aug. 14, 2003

(54) Method and device for detection of a deviating behaviour of a milking animal

(76) Inventor: Uzi Birk, Huddinge (SE)

Correspondence Address: BIRCH STEWART KOLASCH & BIRCH, PO BOX 747, FALLS CHURCH, VA, 22040-0747, US

(21) Appl. No.: 10/297,767

(22) PCT Filed: Jun. 20, 2001
(86) PCT No.: PCT/SE01/01418

(30) Foreign Application Priority Data
Jun. 22, 2000 (SE) 0002355-6

(51) Int. Cl. A01J 3/00; A01J 5/00

(52) U.S. Cl. 119/14.02

(57) ABSTRACT

The present invention relates to a method for detection of a deviating behaviour of a milking animal (101) during milking procedure comprising a sequence in an automatic milking system (100), comprising a robot (105) having a process for positioning teat cups (106). The method comprising the steps of: obtaining an identity of said animal (101), retrieving information related to said animal 101 from a memory (111), said information comprising a reference value derived from a previous milking procedure sequence, registering a value, related to said robot (105), from the present milking procedure sequence, comparing each reference value with the registered value in an analyser (112), and issuing of a warning signal if any of said registered values deviates from the corresponding reference value more than a predetermined deviation value, whereby the process for positioning the teat cups (106) is used for determining if the milking animal (101) deviates from a normal behaviour. The present invention also relates to a device.

### TECHNICAL FIELD

The present invention relates to a method for detection of a deviating behaviour of a milking animal, as is set forth in the preamble of claim 1, more specifically to a method to determine whether said animal performs deviating movements during automatic milking compared to normal. The present invention also relates to a device as set forth in the preamble of claim 9.

### DESCRIPTION OF RELATED ART

It is generally known that the physical health of an animal may be detected by observing a deviating behaviour of the animal compared to a normal behaviour. An example of a deviating behaviour is a restless animal that have an injury, is in a mating-season, is sick or just is newly introduced in a heard.

Several methods are known describing how to detect odd behaviour of an animal, especially for milking animals in an automatic milking system.

The international patent publication WO 94/19931 describes a method and a device for surveying animal functions. This is possible by using sensors that register animal movements to determine if the animal is restless.

In EP 0786203 another method is described where the movements of the milking animal are registered by providing the animal with a step counter on one of its legs. The step counter transfer the number of movements by radio to a central unit, where an analysis takes place to determine if the number of movements is normal compared to earlier results, and thereby establish if the animal is well or not.

These methods experience an essential drawback in that they both require additional hardware to determine if the animal moves during the automatic milking procedure. Additional hardware normally means higher cost for implementation and an additional source of malfunction that may occur during normal operation.

### SUMMARY OF THE INVENTION

The present invention seeks to provide a method and a control device for detection of a deviating behaviour of a milking animal, especially for a cow, which overcomes the prior art problems.

According to an aspect of the present invention, there is provided a method as specified in claim 1.

The invention is also directed to a control device which implements the mentioned method as specified in claim 9.

An advantage with the present invention is that the method is easy and cheap to implement in an automatic milking system.

Another advantage with the present invention is that the method may be used to determine the physical health of a milking animal by registering the movements of the robot during the milking procedure instead of registering the movement of the milking animal.

Still another advantage is that the present invention may be achieved without any additional hardware.

The invention will now be described in more detail with reference to the accompanying drawings.

### BRIEF DESCRIPTION OF DRAWINGS

FIG. 1 shows an overview of an automatic milking system implementing the present invention.

FIGS. 2a and 2b shows graphs for illustrating the function of the invention.

### DETAILED DESCRIPTION OF PREFERRED EMBODIMENTS

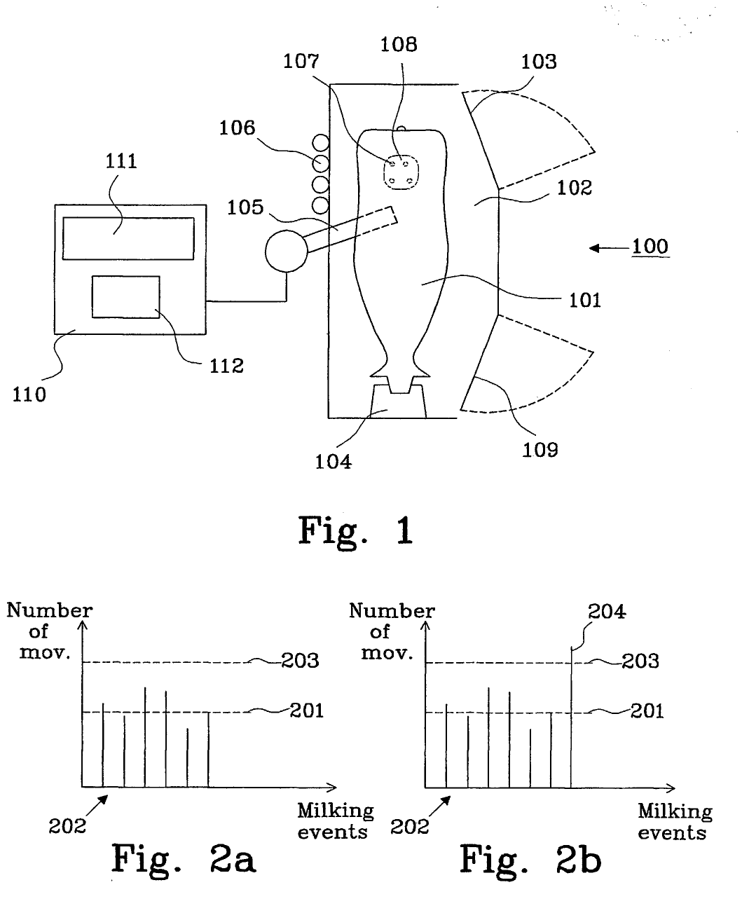

FIG. 1 shows an overview of an automatic milking system 100 according to the present invention, where a milking animal 101 has entered a milking parlour 102 through an entrance 103. The milking animal 101 receives food from a feeding tray 104 upon entering the milking parlour 102. The automatic milking system 100 further comprises an automatic positioning device 105, such as a robot, which detects the position of each teat 107 before applying teat cups 106 to the milking animals teats 107. The teats 107 are arranged on an udder 108. The positioning device 105 also cleans the teats prior to milking by use of a cleaning device (not shown) and the teats may also be disinfected after milking by use of a disinfecting device (not shown). When the milking animal 101 has been milked, an exit gate 109 is opened and the animal 101 may leave the milking parlour to allow the next animal to enter the milking parlour 102 through the entrance 103. The positioning device 105 is connected to a computer 110, comprising a memory 111 and analysing means 112.

The procedure for establishing the position of a teat 107 on a milking animal 101 comprises a number of steps, which cause the positioning device 105 to move. The positioning device 105 normally comprises two lasers that each emit a laser beam, which are detected by a camera to form an image. The positioning device 105 is positioned at a starting point and the positioning device 105 is moved in several steps to establish the position of the teat by analysing each received image in the camera. If the animal moves during the positioning procedure the positioning device may have to restart the procedure from the starting point, which will increase the number of movements compared to normal.

If the positioning device 105 manage to establish the position of a teat 107 and then tries to apply a teat cup 106 to the teat 107, this may cause the animal to move if the teat is injured. This results in that the procedure to establish the position of the teat has to be performed again, which lead to an increase in number of movements to establish the position before the teat cup 106 is applied to the teat 107.

FIGS. 2a and 2b shows graphs illustrating the number of movements for the positioning device 105 before applying a teat cup 106 to a teat 107 as a function of consecutive milking events.

The number of movements in FIG. 2a illustrate normal behaviour of the animal and an average value 201, as a reference value, is calculated based on the registered number of movements 202. A warning level 203 is determined, where the value of the warning level 203 may be established as the reference value 201 plus a predetermined value. The difference between the warning level and the reference value make up the largest acceptable deviation value that is permitted without the system issuing a warning signal. The reference value may shift dependent on how the average value is calculated. The average value may be established on a number of previous movements, e.g. the ten latest number of movements, or may be established on all previously registered number of movements.

FIG. 2b shows a graph where a milking event 204 has a higher value than said warning level 203, which means that the difference between the reference value 201 and the registered number of movements 204 is higher than the largest acceptable deviation value, and a warning signal is thus issued by the system.

When the animal enters the milking parlour, the automatic milking system identifies the animal by reading a transponder fitted to a collar around the neck of the animal (not shown). The computer retrieves previously stored animal related information from the memory 111 regarding the number of movements for the positioning device 105 to perform different steps in the milking procedure, i.e. cleaning, attaching teat cups, disinfecting. The information may also relate to the time to perform these different steps and/or the number of tries to locate each teat and perform each step. This information may be used as reference values during analyses.

The computer 110 register the number of movements of the positioning device 105 during each step of the present milking procedure, including also time and/or the number of tries if desired, and compare these results with the reference values from the memory in the analysing means 112. If the results deviate, more than the predetermined values, from the reference values, the computer 110 will issue a warning signal to alert the farmer that said animal is showing a deviating behaviour. The warning signal may be stored in a log within the computer or immediately sent to the farmer through radio communication, e.g. a SMS-message. Furthermore, the animal is preferably separated from the heard after the milking so that the farmer easily can find the animal which caused the warning signal. If the animal instead would remain in the milking parlour 102, it could not be accessed by other animals waiting to be milked, or if the animal joined the heard after milking, it would be more difficult to find the animal for the farmer.

Each reference value may comprise an average value measured over a predetermined time period for each milking animal or for all animals in the heard.

By establishing the number of movements of the positioning device during the period of time when an animal to be milked is cleaned and/or during the period of time when teat cups are connected to the teats and/or during the period of time when the teats are disinfected, it is possible, by executing the comparisons and averaging process indicated above, to obtain an indication regarding the physical condition of the animal. It is also possible to obtain an indication when registering the period of time for each of the above mentioned steps and compare with an average period of time and/or by registering the number of tries to perform the above mentioned steps and compare with an average number of tries.

1. A method for detection of a deviating behaviour of a milking animal (101) during milking procedure in an automatic milking system (100), said system comprising an automatic positioning device (105) having a process for positioning animal related means (106) and said milking procedure comprises at least one sequence, said method comprising the steps of:
obtaining an identity of said animal (101),
retrieving information related to said animal (101) from a memory (111) in a computer (110), said information comprising at least one reference value derived from at least one sequence of a previous milking procedure,
characterised in that said method further comprises the steps of:
registering at least one value, related to said automatic positioning device (105), from said at least one sequence of the present milking procedure,
comparing each reference value with each registered value in an analysing means (112) in said computer (110), and
issuing of a warning signal from said computer (110) if any of said registered values deviates from the corresponding reference value more than a predetermined deviation value,
whereby the process for positioning the animal related means (106) is used for determining if the milking animal (101) deviates from a normal behaviour.

2. The method according to claim 1, wherein said step of registering at least one value relates to any of the following:
time for said positioning device (105) to position said animal related means (106) for each sequence of said milking procedure; and/or
number of movements of said positioning device (105) for each sequence of said milking procedure; and/or
number of tries for performing positioning said animal related means (106) for each sequence of said milking procedure.

3. The method according to claim 1 or 2, wherein said reference value comprises an average value of previously registered values related to said positioning device (105).

4. The method according to claim 3, wherein said average value is derived from previously registered values related to at least said animal.

5. The method according to claim 3, wherein said average value is derived from previously registered values related to said animal.

6. The method according to any of claim 1-5, wherein said step for issuing a warning signal further comprises a step of sending a message to a supervisor indicating an animal (101) with a deviating behaviour.

7. The method according to any of claim 1-6, wherein said step for issuing a warning signal further comprises a step of adding a record to a log in said computer (110).

8. The method according to any of claim 1-7, wherein said milking animal (101) is separated from the heard if a warning signal is issued.

9. A device for detection of a deviating behaviour of a milking animal (101) during milking procedure in an automatic milking system (100), said milking procedure comprises at least one sequence, said system comprising
an automatic positioning device (105) having a process for positioning animal related means (106),
means for identifying said animal (101), and
means to retrieve information related to said animal (101) from a memory (111) in a computer (110), said information comprising at least one reference value derived from at least one sequence of a previous milking procedure,
characterised in that said device further comprises:
means to register at least one value, related to said automatic positioning device (105), from said at least one sequence of the present milking procedure,
means to compare each reference value with each registered value in an analysing means (112) in said computer (110), and
means to issue a warning signal from said computer (110) if any of said registered values deviates from the corresponding reference value more than a predetermined deviation value from each corresponding reference value,
whereby the device for positioning the animal related means (106) is used for determining if the milking animal (101) deviates from a normal behaviour.
